(19) United States
(12) Patent Application Publication
(10) Pub. No.: US 2009/0249957 A1
(43) Pub. Date: Oct. 8, 2009

(54) Two Stage Air Filter

(76) Inventor: Robert W. Lackey, SR., Hickory, NC (US)

Correspondence Address: NEXSEN PRUET, LLC, P.O. BOX 10648, GREENVILLE, SC, 29603, US

(21) Appl. No.: 12/062,623

(22) Filed: Apr. 4, 2008

(51) Int. Cl. B01D 53/22

(52) U.S. Cl. 96/11

(57) ABSTRACT

A disposable air filter for an HVAC system, especially a re-circulating system, having a first filter layer for removing larger particles and dust, and a second filter layer for removing small particles, especially reprievable particles. An expanded metal screen between layers is disclosed as a second embodiment.

### FIELD OF THE INVENTION

This invention relates to air filters for use in re-circulating HVAC systems and to a method for making them.

### BACKGROUND OF THE INVENTION

Re-circulating HVAC systems have been the standard for 50 years in new housing construction, small businesses, and replacement units for these locations. The typical system draws air from a central location, heats or cools the air, and distributes the air to multiple locations about the building. Early systems located a filter near the input side of the circulating fan(s). Newer systems locate the filter at the mouth of a single large air return duct. The filters are typically one-inch thick and sold in rectangular sizes ranging from 8″×16″ to 24″×30″. Most fit behind a hinged grillwork into a flange at the mouth of the air return duct. The advertised lifetime for these filters is three months. Practical lifetimes may vary.

Commercial filters include coarse glass fibers which collect large particles and pleated filters using synthetic fibers which collect smaller fibers. Electrostatic media of permanently charged polymer are also known.

Examples of filters of this type are U.S. Pat. No. 6,126,707 to Pitzer, and U.S. Pat. No. 6,165,240 to Hodge. Electro-static filter media are described in U.S. Pat. No. 5,800,769 to Haskett, and U.S. Pat. No. 5,976,280 to Rousseau, et al.

Pre-filters, as a concept, are discussed in U.S. Pat. No. 6,533,845 to Tokar.

The space allowed for a furnace filter in a modern domestic HVAC system is 1 inch thick (2.54 cm). No reference teaches a two-layer filter of this type. The filters are considered cheap and disposable and this understanding is reflected in the choice of materials for the components.

### BRIEF DESCRIPTION OF THE INVENTION

The invention is a two layer filter system of the disposable type using a first layer which is a flat polymer mesh electric-statically charged to collect selectively large airborne particles and a second filter layer of a pleated filter, also electrostatically charged, to collect the smaller respireable size particles passing through the large particle filter.

### BRIEF DESCRIPTION OF THE DRAWINGS

FIG. 1 is a schematic of a two-stage filter having a first upstream layer and a second pleated downstream layer superimposed.

FIG. 2 is a schematic of a two-stage air filter having a first upstream layer and a second, pleated downstream layer separated by an expanded metal layer.

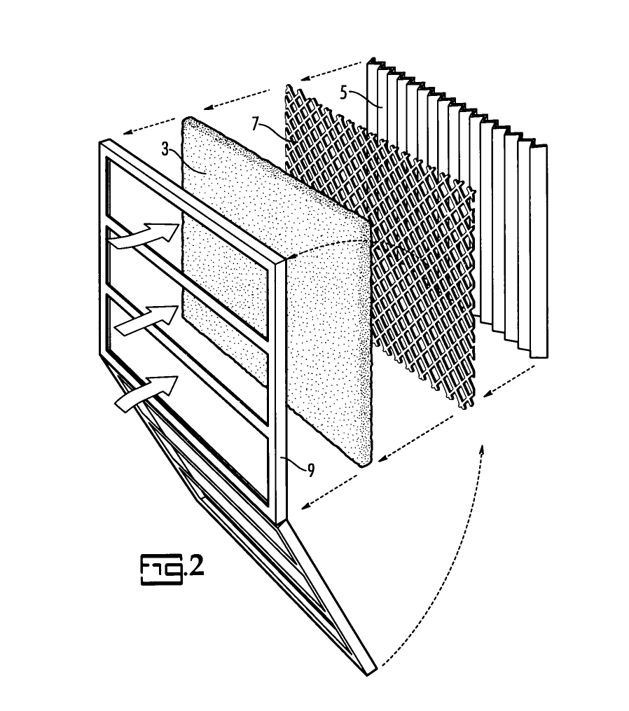

### DETAILED DESCRIPTION OF THE INVENTION

The conventional filter for HVAC in homes and small commercial facilities is a rectangular product sized to the air flow expected to pass through it during use. In most cases, it is set at one-inch depth. The frame is typically a type of cardboard or pasteboard and the filter formed from a variety of fibrous materials from fiberglass to synthetic polymers, but including cotton and other natural fibers. Early filters, typically non-woven with visible gaps, were suitable for removing visible dust but little else. Newer filters have greater efficiency but with an increase in pressure drop across the filters. Since the average household system draws, at most, two inches of water, higher pressure drops can significantly reduce total flowed volume and increase current draw at the circulating fan.

Filters are rated according to Minimum Efficiency Reporting Values (MERV), ASHRAE standard 52.2 in 16 classes. The higher numbers reflect filter efficiency using challenge particles of different sizes and minimum final resistance (in W.G). Higher MERV ratings remove a greater percentage of respireable particles, including allergens.

Airborne allergens and pathogens are of increasing concern as people spend more time indoors and make-up air in offices is reduced to conserve costs. In offices and other facilities with large air handling units, it has become conventional to filter both incoming air and re-circulated air through banks of HEPA filters-depth filters rated for 90% elimination or more of small particles. A “roughing filter” is used to treat at least incoming air to remove soot and dust, thus reducing the loading on the HEPA filters which plug quickly when heavily challenged. In home and small commercial settings, both higher MERV ratings and treated media are being employed. The cost of production is increased as higher quality materials are used and the traditional statement “dispose of after three months” becomes a cost problem. This problem becomes exacerbated when the media are treated with such antibacterial compounds as Ag solutions and salts.

The need therefore is for a method to incorporate a prefilter into a higher MERV, treated media filter.

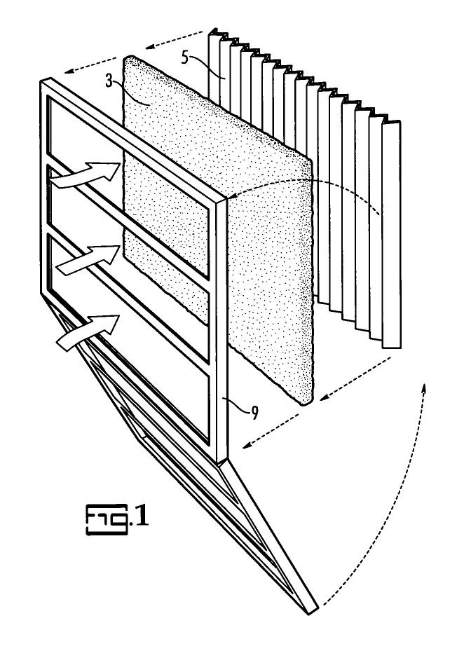

The two stage filter according to this invention, and illustrated in FIG. 1, provides a prefilter 3 on the inlet side of an air filter package, followed by a pleated, higher efficiency filter 2. The prefilter maybe a felted natural, or synthetic fibrous material, a non-woven fiberglass or a paper. The prefilter is characterized by an effective pore size which traps dust, animal hair, bird feathers and sloughed-off skin. Viruses, bacteria and submicroscopic particles, such as cigarette smoke, pass through the prefilter.

The secondary filter 5 is a pleated depth-type filter which may be paper, natural or synthetic fiber with a MERV rating of 10 or higher. The secondary filter is expected to eliminate bacteria, pollen, viruses, mold spores, ragweed, tobacco smoke and many cooking odors which are particulate.

Efficiency may be increased by electrostatic charging one or both filter layers, usually both. The media becomes charged electrostatically by the passage of air across the media. No electrical connections are required. The charging is the result of using media of such films as polypropylene, which develop the static charge from friction with the air. Since many small particles are also charged, they are attracted to the charged media and the efficiency is increased.

In a third embodiment, an expanded metal sheet 7 may separate the two filters. The sheet provides physical support to the structure and provides a precipitation zone to improve total capacity of the filter.

This invention has been described in terms of the preferred embodiments which are not limitations to the scope of the invention. Modifications within the teachings of the invention and obvious to one of ordinary skill in the art are encompassed within the scope and spirit of the invention.

### Industrial Utility

The invention provides greater longevity and efficiency for filters in re-circulating HVAC systems for homes and offices.

The filters are held in a frame 9 of about one inch depth, shown in FIG. 1 in exploded form, but typically one piece, suitably glued. Plastic may be used in place of the typical cardboard but since the filter is disposable, paper is preferred. An elastic surface facing the duct flange may be used to improve sealing.

I claim:

1. A disposable air filter for an HVAC system comprising:
a) a first layer having a large particle cut-off;
b) a second filter layer having a high efficiency and a small particle cut-off; and
c) a frame holding the filters in fixed relationship and sized to fit into a duct flange in the HVAC system.

2. A disposable air filter according to claim 1 wherein both of said first and second filter layers are electrostatically charged.

3. A disposable air filter according to claim 1 having a MERV rating of 10 or higher.

4. A disposable air filter according to claim 1 wherein said second filter layer is pleated.

5. A disposable air filter according to claim 1 further comprising an expanded metal layer between said first and second filter layers.
